(19) United States
(12) Patent Application Publication
(10) Pub. No.: US 2023/0230719 A1
(43) Pub. Date: Jul. 20, 2023

(54) TRANSPARENT FILM AND MANUFACTURING METHOD THEREFOR

(71) Applicant: Resonac Corporation, Tokyo (JP)

(72) Inventor: Masahiko TOBA, Tokyo (JP)

(73) Assignee: Resonac Corporation, Tokyo (JP)

(21) Appl. No.: 18/189,419

(22) Filed: Mar. 24, 2023

Related U.S. Application Data
(63) Continuation-in-part of application No. PCT/JP2021/034123, filed on Sep. 16, 2021.

(30) Foreign Application Priority Data
Sep. 25, 2020 (JP) 2020-160924

(51) Int. Cl. H01B 5/14; H01B 1/22; H01B 13/30

(52) U.S. Cl. CPC H01B 5/14; H01B 1/22; H01B 13/30

(57) ABSTRACT

A transparent film including: a transparent substrate; and a conducting fiber-containing layer that is stacked on at least one main surface of the transparent substrate material and contains conducting fibers substantially evenly dispersed in a plane view and a binder resin. The transparent film has a high resistance part in which an undercoat layer is provided between the transparent substrate material and the conducting fiber-containing layer, and a low resistance part in which the undercoat layer is not provided between the transparent substrate material and the conducting fiber-containing layer. The relationship between a sheet resistance value R_{H} of the high resistance part and a sheet resistance value R_{L} of the low resistance part is expressed as R_{H}/R_{L}>100. The undercoat layer contains a resin having at least one group or boding part having (—NH—).

### CROSS REFERENCE TO RELATED APPLICATION

This is a continuation-in-part application of International Application No. PCT/JP2021/034123 filed on Sep. 16, 2021, and claiming priority based on Japanese Patent Application No. 2020-160924 filed on Sep. 25, 2020.

### TECHNICAL FIELD

The present disclosure relates to a transparent film having a low-resistance part and a high-resistance part, and a production method therefor. In more detail, the present disclosure relates to transparent film comprising a transparent substrate having conducting fibers deposited thereon so as to be substantially evenly distributed in a plan view, and comprising a low-resistance part and a high-resistance part, as well as a production method therefor.

### BACKGROUND ART

A transparent conducting film is used in various fields such as a transparent electrode for devices such as a liquid crystal display (LCD), a plasma display panel (PDP), an organic electroluminescence type display, photovoltaics (PV), and a touch panel (TP), etc., an electro-static discharge (ESD) film, and an electromagnetic interference (EMI) film, etc. For these transparent conducting films, conventionally, a film using ITO (Indium Tin Oxide) has been used. However, there are drawbacks that the supply stability of indium is low, the production cost is high, the flexibility is inferior, and a high temperature is required when the film is formed. Therefore, transparent conducting films which can replace the ITO film has been actively searched. Among such films, a transparent conducting film containing metal nanowires is preferable as a transparent conducting film substituting the ITO film, in view of its superior conductivity, optical property, and flexibility, and its advantages that a film can be formed by a wet process, a production cost is low, and a high temperature is not required at the time of forming a film, and the like. For example, a transparent conducting film containing silver nanowires, and having a superior conductivity, optical property, and flexibility is known (refer to Patent Document 1).

An ordinary transparent conducting film containing conducting fibers such as silver nanowires, etc., has a transparent substrate having thereon a network structure in which a plurality of conducting fibers which are deposited in random directions and are substantially evenly dispersed (distributed) in a plan view so as to have intersections, and thereby, the transparent conducting film presents conductivity with a substantially even sheet resistance value within a plane. When the above device is produced by using a transparent conducting film containing conducting fibers, a conductive pattern having a conductive part (low-resistance part) and a non-conductive part (high-resistance part) has to be formed. As a conventional conductive pattern forming technology, a method for directly forming a conductive pattern on an insulating substrate (a plate-printing such as a screen printing of a conductive ink, etc., a method for drawing a pattern by a plateless-printing such as an inkjet printing, deposition of a conductive material (for example, metal) using a mask) (additive method), a method for forming a solid conductive layer on an insulating substrate, and then, forming a pattern at a region where a non-conductive part is to be formed, by chemical etching, laser etching, etc. (subtractive method), and the like, have been studied. In any of the methods, there are drawbacks that when the conductive part (low-resistance part) and the non-conductive part (high-resistance part) are clearly distinguished, a pattern can be visible (a pattern visibility problem).

In order to solve the above-mentioned pattern visibility problem, namely, as a method for improving non-visibility, Patent Document 1 discloses a method for reducing the haze value difference between the conductive part and the non-conductive part, by adjusting the strength of the etching liquid at the time of patterning the transparent conductive layer having metal nanowires and lowering the concentration of the metal nanowires at the part corresponding to the non-conductive part.

Further, Patent Document 2 discloses a method for forming a non-conductive hole pattern in a conductive part made of a transparent conducting film, and, on the other hand, forming an island pattern made of the transparent conducting film in a non-conductive part where the transparent conducting film is not formed, to thereby use the difference of conducting film coverage rates between the conductive part and the non-conductive part and solve the haze value difference between these parts.

Patent Document 3 discloses that metal fibers are used in a conductive part and a non-conductive part, and a dummy pattern of a plurality of lines is formed on the non-conductive part, to thereby improve the non-visibility.

Further, Patent Document 4 discloses that an undercoat layer is formed to adjust the refraction index of a patterned conductive layer and a covered layer and satisfy a desired spectral reflection factor, and thereby improve the non-visibility.

### PRIOR ARTS

Patent Document 1: Japanese Unexamined Patent Publication (Kohyo) No. 2010-507199

Patent Document 2: Japanese Unexamined Patent Publication (Kokai) No. 2013-12016

Patent Document 3: Japanese Unexamined Patent Publication (Kokai) No. 2016-91627

Patent Document 4: Japanese Unexamined Patent Publication (Kokai) No. 2008-243622

### SUMMARY

The method disclosed in Patent Document 1 has drawbacks that the non-conductive part may become conductive depending on the concentration of the metal nanowire. The method disclosed in Patent Document 2 has drawbacks that the randomness of the hole and island arrangement and the optimum value of filing density must be calculated, the manufacturing design is difficult, and the haze value difference cannot be easily solved. According to the method disclosed in Patent Document 3, the line width of the dummy pattern should be equal to or lower than a threshold value which is individually specified depending on the average diameter, average length of a metal fiber, and should be determined in view of the number of dummy patterns provided in the non-conductive part, the haze value difference between the non-conductive part and the conductive part, and the like. Thus, the manufacturing design is also difficult in the method disclosed in Patent Document 3, similar to the method disclosed in Patent Document 2. According to the method disclosed in Patent Document 4, the pattern visibility problem occurs due to the patterning or pattern-forming of the conductive layer.

Therefore, one of the objectives of the present disclosure is to provide a transparent film having a preferable non-visibility of a low-resistance part (conductive part) and a high-resistance part (non-conductive part), by developing different conductivities without processing the conducting fibers contained in the conducting fiber-containing layer and constituting the low-resistance part (conductive part) and the high-resistance part (non-conductive part), and a production method therefor.

The inventors of the present disclosure found out that, by providing an undercoat made from a specific material on a transparent substrate, and performing a predetermined operation, a transparent film having thereon conducting fibers deposited in a substantially even distribution in a plan view, having a low-resistance part and a high-resistance part, and having a superior non-visibility, can be obtained.

Namely, the present disclosure has the following aspects.

[1] A transparent film comprising a transparent substrate, and a conducting fiber-containing layer stacked on at least one main face of the transparent substrate, the conducting fiber-containing layer containing conducting fibers substantially evenly dispersed in a plan view, and a binder resin, wherein the transparent film has a high-resistance part where an undercoat layer is partly provided between the transparent substrate and the conducting fiber-containing layer, and a low-resistance part where no undercoat layer is provided between the transparent substrate and the conducting fiber-containing layer, a sheet resistance value R_{H} of the high-resistance part and a sheet resistance value R_{L} of the low-resistance part satisfy R_{H}/R_{L}>100, and the undercoat layer contains a resin having at least one group or bonding part having (—NH—). [2] A transparent film according to [1], wherein a total content of the group or bonding part having (—NH—) in the undercoat layer is 0.1 mmol/g or more and 5.0 mmol/g or less.

[3] A transparent film according to [2], wherein the total content of the group or bonding part having (—NH—) is less than 2.0 mmol/g.

[4] A transparent film according to any one of [1] to [3], wherein the group or bonding part having (—NH—) is at least one selected from a group consisting of a primary amino group, a secondary amino group, a urethane bond (—NH—C(═O)—O—), a urea bond (—NH—C(═O)—NH—), and an amide bond (—C(═O)—NH—).

[5] A transparent film according to any one of [1] to [4], wherein the binder resin is a poly-N-vinylacetamide (homopolymer of N-vinylacetamide (NVA)) or a copolymer having 70 mol % or more of N-vinylacetamide (NVA).

[6] A transparent film according to any one of [1] to [5], wherein the undercoat layer has a thickness of 10 to 30000 nm.

[7] A transparent film according to any one of [1] to [6], wherein an overcoat layer (protection film layer) is provided on the conducting fiber-containing layer.

[8] A transparent film according to any one of [1] to [7], wherein the conducting fiber is a metal nanowire.

[9] A transparent film according to [8], wherein the metal nanowire is a silver nanowire.

[10] A manufacturing method for a transparent film comprising: a first step for forming a undercoat layer which covers at least a part of at least one main face of a transparent substrate, and a second step for forming a conducting fiber-containing layer having conducting fibers substantially evenly dispersed in a plan view, the conducting fiber-containing layer covering the undercoat layer as well as a region where no undercoat layer is provided to expose a surface of the transparent substrate, wherein a sheet resistance value R_{H} of the high-resistance part where the undercoat layer is provided and a sheet resistance value R_{L} of the low-resistance part where no undercoat layer is provided satisfy R_{H}/R_{L}>100, and the undercoat layer contains a resin having at least one group or bonding part having (—NH—).

[11] A manufacturing method for a transparent film according to [10], wherein the first step comprises a step of performing pattern printing of the undercoat ink to form a region where the undercoat layer is present and a region where no undercoat layer is present.

[12]A manufacturing method for a transparent film according to [10], wherein the first step comprising: an undercoat layer forming step to apply solid print of the undercoat ink on the transparent substrate, and a step of forming a region with the undercoat layer and a region without the undercoat layer by performing pattern etching of the solid-printed undercoat layer.

[13] A manufacturing method for a transparent film according to any one of [10] to [12], wherein the second step comprising: a step of solid printing of the conducting fiber-containing ink containing conducting fibers, a binder resin, and a solvent, and a step of drying the solvent.

According to the present disclosure, a transparent film having a superior non-visibility of a low-resistance part and a high-resistance part can be provided.

### BRIEF DESCRIPTION OF DRAWINGS

FIG. 1 is a view explaining a mechanism that causes a sheet resistance difference of a conducting fiber-containing layer depending on the presence/absence of an undercoat layer.

FIG. 2 is a view explaining a sheet resistance of a conducting fiber-containing layer when an undercoat resin in which a total content of a group or a bonding part having (—NH—) is 2.0 mmol/g or more, is used.

FIG. 3 is a view (photograph) showing a conducting fiber-containing layer at the low-resistance part (left side) and the high-resistance part (right side) of the transparent film obtained by Example 25 of the present disclosure.

### ASPECTS OF DISCLOSURE

Hereinbelow, aspects of the present disclosure (hereinbelow, referred to as aspects) will be explained.

The first aspect of the present disclosure is a transparent film comprising a transparent substrate, and a conducting fiber-containing layer which is stacked on at least one main face of the transparent substrate, and contains conducting fibers which are substantially evenly dispersed in a plan view and a binder resin, wherein the transparent film has a high-resistance part with an undercoat layer which is partly provided between the transparent substrate and the conducting fiber-containing layer, and a low-resistance part without an undercoat layer, and a relationship between a sheet resistance value R_{H} of the high-resistance part and a sheet resistance value R_{L} of the low-resistance part satisfies R_{H}/R_{L}>100, and the undercoat layer contains a resin having at least one group or bonding part having (—NH—). In the present specification, the terms “high-resistance part” and “low-resistance part” are used such that a part having a relatively high sheet resistance value is referred to as a “high-resistance part”, and a part having a relatively low sheet resistance value is referred to as a “low-resistance part” (hereinbelow, in the present specification, the term “sheet” may be omitted). When R_{H} represents a resistance value of the “high-resistance part”, and R_{L} represents a resistance value of the “low-resistance part”, respectively, R_{H} and R_{L} satisfy R_{H}/R_{L}>100, preferably R_{H}/R_{L}>10³, more preferably R_{H}/R_{L}>10⁵, still more preferably R_{H}/R_{L}>10⁶, and particularly preferably R_{H}/R_{L}>10⁷. R_{H} is preferably more than 10⁴ ω/□, more preferably more than 10⁶ ω/□, and still more preferably more than 10⁸ ω/□. The high-resistance part does not have to be highly insulated. R_{L} is preferably less than 500 ω/□, more preferably less than 100 ω/□, and still more preferably less than 50 ω/□. The low-resistance part does not have to be highly conductive. In the present specification, the term “transparent” refers to that the total light transmittance (transparency to visible light) is 80% or more, and the haze value 3% or less.

### <Transparent Substrate>

The transparent substrate may be colored, but preferably has a high total light transmittance (transparency to visible light), the total light transmittance being preferably 80% or higher. For example, a resin film such as polyester (polyethylene terephthalate [PET], polyethylene naphthalate [PEN], etc.), polycarbonate, acrylic resin (polymethyl methacrylate [PMMA], etc.), cycloolefin polymer, and the like, may be preferably used. As far as the optical property and the electrical property of the transparent substrate is not reduced, and the coating property of the below-mentioned undercoat layer and bending resistance is not reduced, the transparent substrate may be provided with a single layer or a plurality of layers having a function such as easy adhesiveness, optical adjustment (anti-glare, anti-reflection, etc.), hard coating, and so on, on one face or on both faces thereof. For the transparent substrate or the functional layer provided with the transparent substrate, which are the faces on which the below-mentioned undercoat layer is to be coated, a material without a group or bonding part containing (—NH—) is used. Among these resin films, in view of the superior light transmittance (transparency), flexibility, mechanical property, etc., using polyethylene terephthalate, polycarbonate, cycloolefin polymer is preferable. Examples of the cycloolefin polymer include: hydrogenated ring-opening metathesis polymerization type cycloolefin polymer of norbornene (ZEONOR (registered trademark, manufactured by Zeon Corporation), ZEONEX (registered trademark, manufactured by Zeon Corporation), ARTON (registered trademark, manufactured by JSR Corporation), etc.), norbornene/ethylene addition copolymer type cycloolefin polymer (APEL (registered trademark, manufactured by Mitsui Chemicals Inc.), TOPAS (registered trademark, manufactured by Polyplastics Co., Ltd.)). Among these, the material having a glass transition temperature (Tg) 90 to 170° C. is preferable because of its resistance against heat which may be applied during the post process such as lead wiring, connector part production, and the like, and having a glass transition temperature (Tg) of 125 to 145° C. is more preferable. The thickness is preferably 1 to 200 μm, more preferably 5 to 125 μm, still more preferably 8 to 50 μm, and particularly preferably 8 to 20 μm.

### <Undercoat Layer>

The undercoat layer (hereinbelow, may be referred to as “UC layer”) is an insulation layer provided on at least one main face of the transparent substrate to cover the transparent substrate. The undercoat layer may be formed by a film-forming method such as coating, vapor deposition, etc. Preferably, the undercoat layer is formed by coating an undercoat ink (hereinbelow, may be referred to as an “UC ink”) because forming a layer on a large area is easy. The UC layer is formed in a shape of a pattern so that both a region with the UC layer and a region without the UC layer are present on the main face of the transparent substrate.

The undercoat ink to be coated on the transparent substrate is preferably an ink which contains at least one type of a thermoplastic resin, a thermosetting resin, and a photocurable resin having at least one group or bonding part with (—NH—), and is diluted with a solvent. In case of a curable resin, further containing a curable accelerator is preferable. A resin insoluble to a solvent of a conducting fiber-containing ink (hereinbelow, may be referred to as a “conductive ink”) used for forming a conducting fiber-containing layer (hereinbelow, may be referred to as a “conductive layer”) in the post process is preferable, and a resin insoluble to lower alcohol or water is particularly preferable. The resin contained in the undercoat ink may contain one type of resin or a plurality of types of resins having at least one group or bonding part having (—NH—). A resin having no group or bonding part with (—NH—) may be further contained. In a curable resin, if a curing agent or a curable accelerator is used together with a main compound, it is sufficient that at least one of the main compound, curing agent, curable accelerator contains a group or bonding part with (—NH—).

Regarding the resin contained in the undercoat ink (hereinbelow, referred to as an undercoat resin), a total content of a group or bonding part with (—NH—) in the resin (the total number of moles of the group or bonding part with (—NH—) contained in 1 g of the resin) is preferably 0.1 mmol/g or more and 5.0 mmol/g or less, more preferably 0.1 mmol/g or more and 3.0 mmol/g or less, and still more preferably 0.1 mmol/g or more and less than 2.0 mmol/g. The resin contained in the undercoat ink is a resin solid content which finally forms an undercoat layer. In case that the resin is a curable resin, the resin solid content is a total of a resin (main component), a curing agent, and a curable accelerator.

Examples of the group with (—NH—) include a primary amino group and a secondary amino group. Example of a bonding part with (—NH—) include a urethane bond (—NH—C(═O)—O—), a urea bond (—NH—C(═O)—NH—), and an amide bond (—C(═O)—NH—). In case of a group with (—NH—) (primary amino group, secondary amino group), the total content of the group or bonding part with (—NH—) is represented by an amine value. Namely, a resin having an amine value of 0.1 mmol/g or more and 5.0 mmol/g or less is preferable, an amine value of 0.1 mmol/g or more and 3.0 mmol/g or less is more preferable, and an amine value of 0.1 mmol/g or more and less than 2.0 mmol/g is still more preferable. Further, in case that a bonding part with (—NH—) is a urethane bond, a urea bond, or an amide bond, a resin having 0.1 mmol/g or more and 5.0 mmol/g or less of bonding part in 1 g of the resin is preferable, having a bonding part of 0.1 mmol/g or more and 3.0mmol/g or less is more preferable, and having a bonding part of 0.1 mmol/g or more and less than 2.0 mmol/g is still more preferable. Further, in case of a urea bond, one bonding part has two (—NH—), and thus, the number of the bonding parts becomes ½ of the above number, and when the total content is obtained, twice of the number of the bonding parts is used.

When a resin contains a plurality of groups or bonding parts with (—NH—), a resin having a total of the respectively calculated (—NH—) of 0.1 mmol/g or more and 5.0 mmol/g or less is preferable, a resin having a total of 0.1 mmol/g or more and 4.0 mmol/g or less is more preferable, a resin having a total of 0.1 mmol/g or more and 3.0 mmol/g or less is still more preferable, and a resin having a total of 0.1 mmol/g or more and less than 2.0 mmol/g is particularly preferable.

If the total content of the group or bonding part with (—NH—) in the resin is less than 0.1 mmol/g, nitrogenous hydrophilic groups on the coating surface are decreased, and thus, when the below-mentioned conducting fiber-containing layer is formed on the undercoat layer, obtaining a desired insulation property becomes difficult.

When materials having known amine values are mixed, a theoretical value can be obtained by the below-mentioned formula (1). Namely, B g of a material having an amine value of A mgKOH/g, and C g of a material having no amine value (amine value of 0 mgKOH/g) are mixed, the amine value can be calculated as:

Amine Value (mmol/g)=[A×B/(B+C)]/56.11 (1)

When an amine value of a material is unknown, an amine value can be obtained by titration by a titration method described in JIS K 7237.

A theoretical value of a content of a bonding part with (—NH—) in a resin obtained by synthesis can be obtained by synthesis conditions. For example, in case of a urethane bond, E mmol, the total number of moles of polyol, and F mmol, the total number of moles of polyisocyanate, used for synthesizing D g of a urethane resin are compared, and the content can be obtained as follows.
When E>F, content of urethane bond part (mmol/g)=F/D, and
when F>E, content of urethane bond part (mmol/g)=E/D

When a composition of a resin is unknown, the content can be calculated by determining quantities of nitrogen atoms and functional groups subjecting the resin itself to a known analysis method, such as NMR measurement, element analysis measurement, and the like. Further, after a coating is complete, the content can be calculated by quantity determination using a known surface analysis method such as an ESCA method, and the like.

For the solvent contained in the undercoat ink, any solvent can be applied without limitation as far as the solvent can dissolve a resin component (in case of a curable resin, a curable accelerator is included), but cannot dissolve the transparent substrate.

The undercoat ink can be printed by known printing methods such as a bar coating method, a spin coating method, a spray coating method, a gravure printing method, a slit coating method, an inkjet method, and the like. The shape of a printed film or a printed pattern formed by the printing is not particularly limited. Examples thereof may include a shape as a negative pattern of a conductive pattern such as a wiring, an electrode, etc., which can be formed on a transparent substrate (high-resistance part), a shape as a film (solid pattern) covering substantially the entirety of transparent substrate, and the like. The negative pattern can be directly drawn by printing, or can be formed by forming a solid pattern and then removing a region corresponding to a conductive pattern (low-resistance part) such as wiring, electrode, etc., by etching, etc., before forming a conducting fiber-containing layer (coating a conducting fiber-containing ink). The formed undercoat layer (undercoat pattern) is heated to dry the solvent, and thereafter, is cured by applying photoirradiation or heating in accordance with needs. A preferable thickness of the undercoat layer (undercoat pattern) may vary depending on a diameter of a conducting fiber used or a desired sheet resistance value, but preferably 10 to 30000 nm, more preferably 20 to 20000 nm, and still more preferably 30 to 10000 nm. When the thickness is less than 10 nm, forming an even film is difficult, whereas, if the thickness is more than 30000 nm, light transmittance is poor and a preferable transparency cannot be maintained.

Further, as far as the function of the undercoat layer is no lost, additional functional material such ac UV absorbent, (near) infrared absorbing material, etc., may be added. The addition amount may be appropriately adjusted in order to attain a desired wavelength transmittance.

### <Conducting Fiber-Containing Layer>

The conducting fiber-containing layer contains conducting fibers and a binder resin. The conducting fiber may be metal nanowire, carbon fiber, etc., and using the metal nanowire is preferable. The metal nanowire is a conductive material made of metal and having a wire shape with a diameter in the order of nanometer. In the present aspect, in addition to (by mixing with) or instead of the metal nanowire, metal nanotube which is a conductive material having a porous or nonporous tubular shape, may be used. In the present specification, both the “wire shape” and the “tubular shape” refer to a linear shape, but the former refers to a solid body, while the latter refers to a hollow body. Both may be soft or rigid. The former is referred to as “metal nanowire in a narrow sense”, and the latter is referred to a “metal nanotube in a narrow sense”. Hereinbelow, in the present specification, the term “metal nanowire” is used to include both the metal nanowire in a narrow sense and the metal nanotube in a narrow sense. Only the metal nanowire in a narrow sense, or only the metal nanotube in a narrow sense may be used, or they may be mixed for use.

As a method for producing the metal nanowire or the metal nanotube, a known method may be applied. For example, silver nanowires may be synthesized by reducing the silver nitrate under the presence of polyvinylpyrrolidone, using a polyol method (refer to Chem. Mater., 2002, 14, 4736). Similarly, gold nanowires may be synthesized by reducing the gold chloride acid hydrate under the presence of polyvinylpyrrolidone (refer to J. Am. Chem. Soc., 2007, 129, 1733). WO 2008/073143 pamphlet and WO 2008/046058 pamphlet have detailed description regarding the technology of large scale synthesis and purification of silver nanowires and gold nanowires. Gold nanotubes having a porous structure may be synthesized by using silver nanowires as templates, and reducing a gold chloride acid solution. The silver nanowires used as templates are dissolved in the solution by oxidation-reduction reaction with the gold chloride acid, and as a result, gold nanotubes having a porous structure can be produced (refer to J. Am. Chem. Soc., 2004, 126, 3892-3901).

The metal nanowires have an average diameter size of preferably 1 to 500 nm, more preferably 5 to 200 nm, still more preferably 5 to 100 nm, and particularly preferably 10 to 50 nm. The metal nanowires have an average major axis length of preferably 1 to 100 μm, more preferably 1 to 80 μm, still more preferably 2 to 70 μm, and particularly preferably 5 to 50 μm. While satisfying the above average diameter size and the average major axis length, the metal nanowires have an average aspect ratio of preferably more than 5, more preferably 10 or more, still more preferably 100 or more, and particularly preferably 200 or more. Here, the aspect ratio refers to a value obtained by a/b, wherein “b” is approximated to an average diameter size of the metal nanowire and “a” is approximated to an average major axis length thereof. The values “a” and “b” may be measured by a scanning electron microscope (SEM) and an optical microscope. Specifically, “b” (average diameter) is obtained by measuring sizes (diameters) of any selected 100 silver nanowires respectively using the Field Emission Scanning Electron Microscope JSM-7000F (manufactured by JEOL Ltd.), and calculating the arithmetic average thereof. Further, “a” (average length) is obtained by measuring sizes (lengths) of any selected 100 silver nanowires respectively using the Shape Measurement Laser Microscope VK-X200 (manufactured by Keyence Corporation), and calculating the arithmetic average thereof.

The kind of the metal as a material for the metal nanowires may be one selected from the group consisting of gold, silver, platinum, copper, nickel, iron, cobalt, zinc, ruthenium, rhodium, palladium, cadmium, osmium, and iridium, or may be an alloy etc., formed by combining some of these. In order to obtain a coating film having a low sheet resistance and a high total light transmittance, containing at least one of gold, silver, and copper is preferable. These metals have a high conductivity, and thus, when a certain sheet resistance should be obtained, the density of the metal within the surface may be reduced, and high total light transmittance can be achieved. Among these metals, containing at least gold or silver is more preferable. The most appropriate example may be the silver nanowire.

As for the binder resin contained in the conducting fiber-containing layer, any transparent binder can be used with no limitation. In case that metal nanowire produced by the poly-ol method is used as a conducting fiber, a binder resin soluble in alcohol, water or a mixture solvent of alcohol and water is preferable, in view of the compatibility to the solvent for production (polyol). Specifically, the binder may be poly-N-vinyl pyrrolidone, a water-soluble cellulose resin such as methyl cellulose, hydroxyethyl cellulose, carboxymethyl cellulose, and the like, a butyral resin, or poly-N-vinylacetamide (PNVA (registered trademark)). Among them, a resin containing a carbonyl group is more preferable. Poly-N-vinylacetamide is a homopolymer of N-vinylacetamide (NVA), but a copolymer having 70 mol % or more of N-vinylacetamide (NVA) may also be used. Examples of a monomer which can be copolymerized with NVA include: N-vinylformamide, N-vinylpyrrolidone, acrylic acid, methacrylic acid, sodium acrylate, sodium methacrylate, acrylamide, acrylonitrile, and the like. The more the content of the copolymerized component, the higher the sheet resistance of the transparent conducting film to be obtained, the lower the adhesion between the conducting fibers and the transparent substrate, and the lower the heat resistance (thermal decomposition starting temperature). Therefore, the polymer contains the monomer unit derived from N-vinylacetamide preferably 70 mol % or more, more preferably 80 mol % or more, and still more preferably 90 mol % or more. Such a polymer has an absolute molecular weight of preferably 30,000 to 4,000,000, more preferably 100,000 to 3,000,000, and still more preferably 300,000 to 1,500,000. The absolute molecular weight was measured by the following method.

### <Absolute Molecular Weight Measurement>

The binder resin was dissolved in the following eluent, which was left to stand still for 20 hours. The concentration of the binder resin in the resultant solution was 0.05% by mass.

The solution was filtered by a 0.45 μm membrane filter, the filtrate was measured by GPC-MALS.
GPC: Shodex (registered trademark) SYSTEM 21, manufactured by Showa Denko K.K.
Column: TSK gel (registered trademark) G6000PW, manufactured by Tosoh Corporation
Column Temperature: 40° C.
Eluent: 0.1 mol/L of NaH₂PO₄ aqueous solution +0.1 mol/L of Na₂HPO₄ aqueous solution
Flow Rate: 0.64 mL/min
Sample Injection Volume: 100 μL
MALS Detector: DAWN (registered trademark), manufactured by Wyatt Technology Corporation
DSP Laser Wavelength: 633 nm
Multi-Angle Fitting Method: Berry Method

The above binder resin may be used solely, or two or more kinds of the binder resin may be used in combination. When two or more kinds are mixed, a simple mixture of them, or a copolymer may be used.

Preferably, the conducting fiber-containing layer is formed by printing, in solid print, a conducting fiber-containing ink containing the conducting fibers, the binder resin, and the solvent, on the undercoat layer, the undercoat layer being provided on at least one main face of the transparent substrate, to form a part covering the transparent substrate and a part not-covering the transparent substrate (the undercoat layer partly covering the transparent substrate), and then, and drying and removing the solvent. Here, “solid print” means printing the conducting fiber-containing ink both on the part where the transparent substrate is covered by the undercoat layer and the part where the transparent substrate is not covered by the undercoat layer.

The solvent contained in the conducting fiber-containing ink is not particularly limited as far as the solvent has a superior conducting fiber dispersibility, and the binder resin can be dissolved in the solvent, and the undercoat layer is not dissolved in the solvent. However, if the metal nanowire synthesized by the poly-ol method is used as the conducting fiber, alcohol, water or a mixture solvent of alcohol and water is preferable, in view of the compatibility to the solvent used for production (polyol). As mentioned above, a preferable binder resin is also a binder resin soluble to alcohol, water, or a mixture solvent of alcohol and water. The mixture solvent of alcohol and water is more preferable because the drying speed of the binder resin can be easily controlled. As an alcohol, at least one kind of saturated monohydric alcohols having 1 to 3 carbon atoms (methanol, ethanol, n-propanol, and isopropanol), which are represented by CₙH₂ₙ₊₁OH (n being an integer of 1 to 3) (hereinbelow, simply referred to as “saturated monohydric alcohol having 1 to 3 carbon atoms”). Containing 40% by mass or more of the saturated monohydric alcohol having 1 to 3 carbon atoms in the alcohol in total is preferable. Using the saturated monohydric alcohol having 1 to 3 carbon atoms is advantageous because drying process becomes easy. Alcohols other than the saturated monohydric alcohol having 1 to 3 carbon atoms can be used together. Examples of other alcohols which can be used together with the saturated monohydric alcohol having 1 to 3 carbon atoms include ethylene glycol, propylene glycol, ethylene glycol monomethylether, ethylene glycol monoethylether, propylene glycol monomethylether, propylene glycol monoethylether, and the like. Using such alcohol together with above-mentioned saturated monohydric alcohol having 1 to 3 carbon atoms is advantageous because the drying speed can be adjusted. Further, the content of the alcohol in total in the mixture solvent is preferably 5% to 90% by mass. If the content is less than 5% by mass, or more than 90% by mass, there are drawbacks that a stripe pattern (uneven coating) is generated at the time of coating.

The conducting fiber-containing ink can be produced by stirring and mixing the conducting fibers, the binder resin, and the solvent, using a planetary centrifugal stirrer, and the like. The content of the binder resin in the conducting fiber-containing ink is preferably in the range of 0.01% to 1.0% by mass. The content of the conducting fiber in the conducting fiber-containing ink is preferably in the range of 0.01% to 1.0% by mass. The content of the solvent in the conducting fiber-containing ink is preferably in the range of 98.0% to 99.98% by mass.

The conducting fiber-containing ink may be printed by a bar-coating method, a spin-coating method, a gravure printing method, a slit-coating method, and the like. The shape of the printed film or pattern formed thereby is not limited. However, since the shape of the high-resistance part is determined depending on the shape of the undercoat pattern, a preferable shape is a film covering the entirety or a part of the transparent substrate to include an undercoat pattern forming region (solid pattern). A region of the coating film directly formed on the transparent substrate by heating the coating film thus formed to dry the solvent becomes a low-resistance part, whereas a region of the coating film formed on the undercoat pattern becomes a high-resistance part. Thereby, a transparent film having a conducting fiber-containing layer can be formed. Distributions of the conducting fibers are substantially the same between the low-resistance part and the high-resistance part. Namely, in a plan view (in a view from directly above), deposition concentrations of conducting fibers (mass of conducting fibers per unit area) are substantially the same between the low-resistance part and the high-resistance part. A preferable thickness of the conducting fiber-containing layer obtained after the solvent is dried may be different depending on the diameter of the conducting fiber used and a desired sheet resistance value, but the thickness is preferably 10 to 300 nm, more preferably 20 to 250 nm, and still more preferably 30 to 200 nm. If the thickness is less than 10 nm, the thickness is thinner than the diameter of a nanowire, and forming an even coating film becomes difficult. Whereas, if the thickness is larger than 300 nm, light transmission becomes difficult, and a preferable optical property cannot be obtained. Further, because of the large thickness, a desired sheet resistance value may not be obtained on the undercoat layer. In accordance with needs, the high-resistance part on the undercoat layer can be treated to become low-resistance. The high-resistance part can be made to low-resistance by etching the binder resin constituting the conducting fiber-containing layer by pulse photoirradiation, sodium hydroborate solution, etc. It seems that this occurs because when the etching is applied to the binder resin, the amount of the binder resin around the conducting fibers is reduced.

### <Protection Film>

In order to protect the conducting fiber-containing layer, a protection film may be provided. The protection film is a cured film of a curable resin composition. The curable resin composition preferably comprises (A) a polyurethane containing a carboxy group, (B) an epoxy compound, (C) a curing accelerator, and (D) a solvent. The curable resin composition is applied on the conducting fiber-containing layer by printing, coating, etc., and cured to form the protection film. Curing of the curable resin composition can be performed by heating and drying a thermosetting resin composition. When a photocurable resin composition is used as a curable resin composition, curing occurs by light absorption, and thus, a light absorbing component remains in a cured film. Therefore, preferably, the photocurable resin composition should be used within a range that the total light transmittance and the bending resistance are well balanced.

More specifically, the (A) polyurethane containing a carboxy group is polyurethane synthesized by using (a1) a polyisocyanate compound, (a2) a polyol compound, and (a3) a dihydroxy compound containing a carboxy group, as monomers. From the viewpoint of weather resistance and light resistance, preferably, each of (a1), (a2), and (a3) does not contain a functional group with conjugate properties such as an aromatic compound. For example, disclosure can be found in WO 2018/101334. Same as the undercoat layer, as far as the function is not lost, another functional material, for example, UV absorbent, (near) infrared absorbing material, etc., can be added. The amount of addition may be appropriately adjusted to have a desired wavelength transmittance.

Using the curable resin composition, and applying a printing method such as a bar-coating method, a gravure printing method, an inkjet method, a slit-coating method, etc., the curable resin composition is coated on a substrate on which a metal nanowire layer is formed, the solvent is dried and removed, and thereafter, the curable resin is cured to form a protection layer. The protection film obtained after the curing has a thickness of 50 nm or more and 300 nm or less. By forming the protection film having a thickness of the above range on the conducting fiber-containing layer, a transparent film having a superior bending resistance can be produced. The thickness of the protection film is preferably more than 100 nm and 300 nm or less, more preferably more than 100 nm and 200 nm or less, still more preferably more than 100 nm and 150 nm or less, and particularly preferably more than 100 nm and 120 nm or less. If the thickness exceeds 300 nm, conduction to wires in the post process becomes difficult.

Conventionally, in order to obtain a difference in conductivity between the low-resistance part and the high-resistance part, the conducting fiber itself is processed. However, according to the present disclosure, the conducting fiber itself is not processed, but the structure of the undercoat layer provided on the transparent substrate has been created to form the low-resistance part and the high-resistance part having substantially the same conducting fiber deposition distribution (amount of deposition per unit area), and as a result, a transparent conducting film having a superior non-visibility can be obtained.

The conducting fiber deposition distribution can be confirmed by any selected surface observation method, but confirming by the above-mentioned laser microscope is preferably. In case of an observation method in which focusing is performed, such as a method using a microscope, simultaneously focusing the undercoat layer formed part and the substrate part (part that the undercoat layer is not formed) is difficult because there is a level difference therebetween, and thus, each part is respectively observed, and the observation results are compared.

The second aspect of the present disclosure is a method for producing a transparent film which comprises a first step of forming an undercoat layer covering at least a part of at least one main face of a transparent substrate, and a second step of forming a conducting fiber-containing layer covering the undercoat layer and a region which is not covered by the undercoat layer to expose the surface of the transparent substrate (referred to as a transparent substrate exposed surface), the conducting fiber-containing layer being a layer in which conducting fibers are substantially evenly dispersed in a plan view, wherein a sheet resistance value R_{H} at the high-resistance part where the undercoat layer is present and a sheet resistance value R_{L} at the low-resistance part where the undercoat layer is absent satisfies R_{H}/R_{L}>100, and the undercoat layer contains a resin containing at least one group or bonding part having (—NH—)

The structure of the transparent film produced by the transparent film production method according to the second aspect of the present disclosure is explained in the first aspect of the disclosure, and thus, explanation is omitted here. In the first step, an undercoat layer is formed on at least one main face of the transparent substrate to have a region covering the transparent substrate and a region not-covering the transparent substrate (to partly cover the transparent substrate). The method for forming the undercoat layer (UC layer) may be a method for selectively forming the UC layer on a region corresponding to the high-resistance part on the main face of the transparent substrate, or a method for coating an undercoat ink on substantially the entirety of the main face of the transparent substrate (solid printing), and after the coating, removing the coating of the unnecessary part (a region to become a low-resistance part) so that a covered part is remained. Either case can be performed by printing an undercoat ink, by which forming on a large area is easy. Namely, in the former method, pattern printing is performed so that the undercoat ink is printed on the transparent substrate to have a predetermined shape. In the latter method, the undercoat ink is printed on the entirety of the transparent substrate, and thereafter, pattern etching is performed to remove unnecessary parts so that the solid-printed undercoat layer becomes a layer having a predetermined shape. The pattern etching may be performed by any etching methods suitable for the undercoat resin used, such as dry etching, wet etching.

The second step is a conducting fiber-containing layer forming step which comprises: a step of solid-printing a conducting fiber-containing ink containing conducting fibers, a binder resin, and a solvent, to cover the entirety or a part of the main face of the transparent substrate formed in the first step to have a part covered by the undercoat layer and a part not-covered by the undercoat layer, namely, to cover the entirety or a part of both the undercoat layer partly covering the main face and the transparent substrate exposed surface; and a step of drying the solvent. As explained regarding the first aspect, a region of the conducting fiber-containing layer formed by coating the conducting fiber-containing ink directly on the transparent substrate becomes a low-resistance part, and a region of the conducting fiber-containing layer formed by coating the conducting fiber-containing ink on the undercoat layer (undercoat pattern) becomes a high-resistance part. Therefore, the conducting fiber-containing layer is formed to entirely or partly cover both the part that the undercoat layer covers the main face of the transparent substrate and the part that the undercoat layer does not cover the main face of the transparent substrate (transparent substrate exposed surface). Preferably, the conducting fiber-containing ink containing conducting fibers, a binder resin, and a solvent, is solid-printed to entirely or partly cover both the part that the undercoat layer covers the main face of the transparent substrate and the part that the undercoat layer does not cover the main face of the transparent substrate. Thereby, the conducting fiber-containing layer can be formed to have a substantially even thickness enabling the optical properties (transparencies) of the part covered by the undercoat layer (high-resistance part) and the part not covered by the undercoat layer (low-resistance part) to be substantially equal, and to have a substantially even conducting fiber distribution (deposition concentration).

After the conducting fiber-containing layer is formed, further providing a protection film (overcoat layer) for protecting the conducting fiber-containing layer is preferable. In case that the low-resistance part and the high-resistance part are formed on both of the main faces of the transparent substrate, preferably, the first step, the second step, and, if necessary, the formation of the protection layer are sequentially performed on one main face, and thereafter, the first step, the second step, and, if necessary, the formation of the protection layer are sequentially performed on the other main face.

### EXAMPLES

Hereinbelow, specific examples of the present disclosure will be specifically explained. The examples are described below for the purpose of easy understanding of the present disclosure, and the present disclosure is not limited to these examples.

### <Preparation of Silver Nanowire>

Poly-N-vinylpyrrolidone K-90 (manufactured by Nippon Shokubai Co., Ltd.) (0.98 g), AgNO₃ (1.04 g), and FeCl₃ (0.8 mg) were dissolved in ethylene glycol (250 ml), and subjected to thermal reaction at 150° C. for one hour. The obtained silver nanowire coarse dispersion liquid was dispersed in 2000 ml of methanol, which was poured into a desktop small tester (using ceramic membrane filter Cefilt, membrane area: 0.24 m², pore size: 2.0 μm, size Φ: 30 mm×250 mm, filter differential pressure: 0.01 MPa, manufactured by NGK Insulators, Ltd.), and was subjected to cross-flow filtration at a circulation flow rate of 12 L/min and a dispersion liquid temperature of 25° C., to remove impurities. Thereby, silver nanowires (average diameter: 26 nm, average length: 20 μm) were obtained. The average diameter of the obtained silver nanowires was obtained by measuring sizes (diameters) of arbitrarily selected 100 silver nanowires using Field Emission Scanning Electron Microscope JSM-7000F (manufactured by JEOL Ltd.), and calculating the arithmetic average value of the measurement results. Further, the average length of the obtained silver nanowires was obtained by measuring sizes (lengths) of arbitrarily selected 100 silver nanowires using the Shape Measurement Laser Microscope VK-X200 (manufactured by Keyence Corporation), and calculating the arithmetic average value of the measurement results. For the methanol, ethylene glycol, AgNO₃, and FeCl₃, those manufactured by FUJIFILM Wako Pure Chemical Corporation were used.

### PREPARATION EXAMPLE

### <Preparation of Silver Nanowire Ink 1>

11 g of dispersion liquid of silver nanowires synthesized by the above polyol method in a water/methanol/ethanol mixture solvent (silver nanowire concentration: 0.62% by mass, water/methanol/ethanol=10:20:70 [mass ratio]), 2.4 g of water, 3.6 g of methanol (manufactured by FUJIFILM Wako Pure Chemical Corporation), 8.3 g of ethanol (manufactured by FUJIFILM Wako Pure Chemical Corporation), 12.8 g of propyleneglycol monomethyl ether (PGME, manufactured by FUJIFILM Wako Pure Chemical Corporation), 1.2 g of propyleneglycol (PG, manufactured by AGC Inc.), and 0.7 g PNVA (registered trademark) aqueous solution (solid content concentration: 10% by mass, weight-average molecular weight: 900,000, manufactured by Showa Denko K.K.) were mixed and stirred by Mix Rotor VMR-5R (manufactured by AS ONE Corporation) for 1 hour, at a room temperature and under an air atmosphere (rotation speed: 100 rpm), to thereby produce 40 g of silver nanowire ink.

### <Preparation of Silver Nanowire Ink 2>

Except that the binder resin of the silver nanowire ink 1 was changed to PVP K-90 (poly(N-vinylpyrrolidone), manufactured by Nippon Shokubai Co., Ltd.), the preparation was performed in the same way as the silver nanowire ink 1.

### <Preparation of Silver Nanowire Ink 3>

Except that the binder resin of the silver nanowire ink 1 was changed to ETHOCEL (registered trademark) STD100cps (ethyl cellulose, manufactured by Nisshin Kasei Co., Ltd.), the preparation was performed in the same way as the silver nanowire ink 1.

### <Preparation of Silver Nanowire Ink 4>

Except that the binder resin of the silver nanowire ink 1 was changed to S-LEC (registered trademark) BM-1 (polyvinyl butyral, manufactured by Sekisui Chemical Co., Ltd.), the preparation was performed in the same way as the silver nanowire ink 1.

### <Synthesis Example of (A) Polyurethane Containing Carboxyl Group>

### Synthesis Example 1

211 g of C-1015N (polycarbonate diol, molar ratio of raw material diols: 1,9-nonanediol/2-methyl-1,8-octanediol=15/85, molecular weight: 964, manufactured by Kuraray Co., Ltd.) as a polyol compound, 40.0 g of 2,2-dimethylol butanoic acid (manufactured by Huzhou Changsheng Chemical Co., Ltd.) as a dihydroxy compound containing a carboxy group, and 463 g of propyleneglycol monomethyl ether acetate (manufactured by FUJIFILM Wako Pure Chemical Corporation) as a solvent were provided in a 2 L three-neck flask having a stirrer, a thermometer, and a condenser, and the 2,2-dimethylol butanoic acid was dissolved at 90° C.

The temperature of the reaction liquid was lowered to 70° C., and 128 g of Desmodur (registered trademark)-W (methylene bis(4-cyclohexyl isocyanate), manufactured by Sumika Covestro Urethane Co., Ltd.) as a polyisocyanate compound was dropped thereto for 30 minutes by a dropping funnel. After the dropping was complete, the reaction was performed at 80° C. for 1 hour, then, 100° C. for 1 hour, and then, 120° C. for 2 hours. After the confirmation by IR that almost all of the isocyanate disappeared, reaction was further performed at 120° C. for 1.5 hours. The obtained carboxyl group-containing polyurethane 1 had a weight average molecular weight of 34100, and its solid content had an acid value of 18.2 mg-KOH/g.

The weight-average molecular weight is a polystyrene equivalent value measured by gel permeation chromatography (hereinafter, referred to as GPC). Measurement conditions of GPC are as follows.

Device Name: HPLC unit HSS-2000, manufactured by JASCO Corporation

Column: Shodex Colum LF-804

Mobile Phase: tetrahydrofuran (manufactured by FUJIFILM Wako Pure Chemical Corporation)

Flow Rate: 1.0 mL/min

Detector: RI-2031 Plus, manufactured by JASCO Corporation

Temperature: 40.0° C.

Sample Volume: sample loop 100 μL

Sample Concentration: Prepared to approximately 0.1% by mass

The acid value of a resin solid content is a value measured by the following method.

Approximately 0.2 g of sample is precisely weighed by a precision balance into a 100 ml Erlenmeyer flask, and 10 ml of a mixture solvent of ethanol (manufactured by FUJIFILM Wako Pure Chemical Corporation)/toluene (manufactured by FUJIFILM Wako Pure Chemical Corporation)=½ (mass ratio) is provided thereto to dissolve the sample. Further, 1 to 3 drops of a phenolphthalein ethanol solution (manufactured by FUJIFILM Wako Pure Chemical Corporation) is added to the container as an indicator, which is sufficiently stirred until the sample becomes uniform. The resultant is subjected to titration with a 0.1 N potassium hydroxide-ethanol solution (manufactured by FUJIFILM Wako Pure Chemical Corporation). When the indicator continues to be in light red for 30 seconds, it is determined that the neutralization ends. The value obtained from the result using the following calculation formula is treated as an acid value of the resin.

Acid Value (mg-KOH/g)=[B×f×5.611]/S

B: Use amount (ml) of 0.1 N potassium hydroxide-ethanol solution

f: Factor of 0.1 N potassium hydroxide-ethanol solution

S: Collection quantity (g) of sample

### Synthesis Example 2

Except that C-1015N was changed to 62.0 g, Desmodur (registered trademark)-W was changed to 87.4 g, and propyleneglycol monomethyl ether acetate (manufactured by FUJIFILM Wako Pure Chemical Corporation) was changed to 231 g, other operations were the same as those of Synthesis Example 1, and thus, carboxyl group-containing polyurethane 2 was obtained. The obtained carboxyl group-containing polyurethane 2 had a weight-average molecular weight of 35300, and its solid content had an acid value of 36.1 mg-KOH/g.

### Synthesis Example 3

Except that C-1015N was changed to 12.2 g, Desmodur (registered trademark)-W was changed to 74.1 g, and propyleneglycol monomethyl ether acetate (manufactured by FUJIFILM Wako Pure Chemical Corporation) was changed to 154 g, other operations were the same as those of Synthesis Example 1, and thus, carboxyl group-containing polyurethane 3 was obtained. The obtained carboxyl group-containing polyurethane 3 had a weight-average molecular weight of 35800, and its solid content had an acid value of 53.9 mg-KOH/g.

### Synthesis Example 4

100 g of solution containing the carboxyl group-containing polyurethane 1 obtained by Synthesis Example 1 (solid content concentration: 45% by mass, acid value: 36.2 mg-KOH/g) was provided in a 300 ml of autoclave, and subjected to nitrogen gas replacement. Thereafter, 7.49 g of propylene oxide (purchased from Tokyo Chemical Industry Co., Ltd.) was introduced to the autoclave by a pump, 0.5 MPa of nitrogen gas pressure was applied, and the temperature of the resultant was raised to 120° C. and reacted for 6 hours. In this reaction, the preparation molar ratio ((Epoxy)/(Acid)) of the propylene oxide (epoxy group) relative to the carboxyl group in the carboxyl group-containing polyurethane was 4. The solid content of the obtained resin composition had a weight-average molecular weight of 28000, an acid value of almost zero, a hydroxyl value of 19.4 mg-KOH/g, and a solid content concentration of 41% by mass.

The hydroxyl value is measured as follows.

Approximately 2.0 g of a sample is precisely weighed by a precision balance into a 200 ml round-bottom flask, to which 5 ml of an acetylation reagent is added using a pipette. The resultant in the round-bottom flask provided with an Dimroth condenser is heated by an oil bath adjusted at 95° C. to 100° C. for 1 hour. The resultant is left to be cooled, and thereafter, the liquid on the flask wall is washed into the flask using 1 ml of pure water, and the flask is shaken well. Further, the resultant in the flask provided with an Dimroth condenser is heated by an oil bath adjusted at 5° C. to 100° C. for 10 minutes. The resultant is left to be cooled, and thereafter, the flask wall is washed using 5 ml of ethanol. Several drops of phenolphthalein solution (manufactured by FUJIFILM Wako Pure Chemical Corporation) is added as an indicator, which is subjected to titration with a 0.5 mol/L potassium hydroxide-ethanol solution (manufactured by FUJIFILM Wako Pure Chemical Corporation). When the indicator continues to be in light red for 30 seconds, it is determined that the reaction ends. Also, the above test was performed without providing the sample, as a blank test. The value obtained from the result using the following calculation formula is treated as a hydroxyl value of the resin.

hydroxyl value (mg-KOH/g)=[(B−C)×f×28.05]/S+D

B: Amount (ml) of 0.5 mol/L potassium hydroxide-ethanol solution used in blank test

C: Amount (ml) of 0.5 mol/L potassium hydroxide-ethanol solution used in titration

f: Factor of 0.5 mol/L potassium hydroxide-ethanol solution

S: Collection quantity (g)sample

D: acid value

The acetylation reagent was prepared by providing 25 g of acetic anhydride (manufactured by FUJIFILM Wako Pure Chemical Corporation) into a 100 ml brown volumetric flask, to which pyridine (manufactured by FUJIFILM Wako Pure Chemical Corporation) was added, so that the resultant became 100 ml.

### <Preparation of Undercoat Ink 1>

10 g of the resin composition synthesized by Synthesis Example 4 was diluted by 127 g of ethyl acetate to have a solid content concentration 3% by mass, which was an undercoat ink 1.

### <Preparation of Undercoat Ink 2>

10.0 g of the resin composition synthesized by the Synthesis Example 2 (carboxyl group-containing polyurethane 2 (content of carboxyl group-containing polyurethane: 45% by mass) was weighed in a polyethylene container, and 83.8 g of 1-hexanol (manufactured by FUJIFILM Wako Pure Chemical Corporation) and 83.8 g of ethyl acetate (manufactured by FUJIFILM Wako Pure Chemical Corporation) were added thereto, which was stirred by Mix Rotor VMR-5R (manufactured by AS ONE Corporation) for 12 hours, at a room temperature and under an air atmosphere (rotation speed: 100 rpm). When the mixture was visually confirmed as being uniform, 0.63 g of pentaerythritol tetraglycidyl ether (PETG, manufactured by Showa Denko K.K.) as an epoxy compound and 0.31 g of U-CAT (registered trademark) 5003 (manufactured by San-Apro Ltd.) as a curing accelerator were added thereto, which were stirred again by Mix Rotor for 1 hour. Thereby, an undercoat ink 2 was obtained.

### <Preparation of Undercoat Ink 3>

The resin composition synthesized by Synthesis Example 2, which was used for preparing the undercoat ink 2, was changed to the resin composition synthesized by Synthesis Example 3 (carboxyl group-containing polyurethane 3 (content of carboxyl group-containing polyurethane: 45% by mass)), the amounts of 1-hexanol and ethyl acetate were respectively changed to 89.0 g, the amount of PETG was changed to 0.95 g, and the amount of U-CAT (registered trademark) 5003 (manufactured by San-Apro Ltd.) was changed to 0.33 g. Then, an ink was prepared in the same way, and the resultant was an undercoat ink 3.

### <Preparation of Undercoat Ink 4>

The resin composition synthesized by Synthesis Example 2, which was used for preparing the undercoat ink 2, was changed to the resin composition synthesized by Synthesis Example 1 (carboxyl group-containing polyurethane 1 (content of carboxyl group-containing polyurethane: 45% by mass)), the amounts of 1-hexanol (manufactured by FUJIFILM Wako Pure Chemical Corporation) and ethyl acetate (manufactured by FUJIFILM Wako Pure Chemical Corporation) were respectively changed to 78.6 g, the amount of PETG was changed to 0.32 g, and the amount of U-CAT (registered trademark) 5003 (manufactured by San-Apro Ltd.) was changed to 0.29 g. Then, an ink was prepared in the same way, and the resultant was an undercoat ink 4.

### <Preparation of Undercoat Ink 5>

10 g of jER (registered trademark) 154 (phenol novolak type epoxy resin, manufactured by Mitsubishi Chemical Corporation) was dissolved in 323 g of diethylene glycol monoethyl ether acetate (ECA) (manufactured by FUJIFILM Wako Pure Chemical Corporation), to which 0.5 g of 2E4MZ (Curezol (registered trademark), manufactured by Shikoku Chemicals Corporation) was mixed as a curable accelerator, and the resultant was an undercoat ink 5.

### <Preparation of Undercoat Ink 6>

Except that the jER (registered trademark) 154 in the undercoat ink 5 was changed to jER (registered trademark) 1010 (Bis-A type epoxy resin, manufactured by Mitsubishi Chemical Corporation), other processes were performed in the same way to produce an undercoat ink 6.

### <Preparation of Undercoat Ink 7>

10 g of jER (registered trademark) 1002 (Bis-A type epoxy resin ,catalog molecular weight Mn1, 200, manufactured by Mitsubishi Chemical Corporation) was dissolved in 366 of diethylene glycol monoethyl ether acetate (ECA) (manufactured by FUJIFILM Wako Pure Chemical Corporation), to which 1.32 g of YN100 (jER Cure (registered trademark), a modified polyamide amine, amine value: 340 mgKOH/g, manufactured by Mitsubishi Chemical Corporation) was mixed as a curing agent, and the resultant was an undercoat ink 7.

### <Preparation of Undercoat Inks 8 to 13>

Except that the jER (registered trademark) 1002 used for preparing the undercoat ink 7 was changed to epoxy resins shown in Table 1, and the use amount of YN100 and amount of the solvent were changed, each ink was produced in the same way. The epoxy resins used instead of the jER (registered trademark) 1002 were as follows.

jER (registered trademark) 1004 (Bis-A type epoxy resin. catalog molecular weight Mn1, 650, manufactured by Mitsubishi Chemical Corporation)

jER (registered trademark) 1007 (Bis-A type epoxy resin, catalog molecular weight Mn2, 900, manufactured by Mitsubishi Chemical Corporation)

jER (registered trademark) 1009 (Bis-A type epoxy resin, catalog molecular weight Mn3, 800, manufactured by Mitsubishi Chemical Corporation)

jER (registered trademark) 604 (diaminodiphenylmethane type semi-solid epoxy resin, manufactured by Mitsubishi Chemical Corporation)

### <Preparation of Undercoat Ink 14>

Except that the amounts of 1-hexanol (manufactured by FUJIFILM Wako Pure Chemical Corporation) and ethyl acetate (manufactured by FUJIFILM Wako Pure Chemical Corporation) used for preparing the undercoat ink 2 were respectively changed to 5.4 g, and the solid content concentration was changed to 25% by mass, other processes were performed in the same way, to thereby prepare an undercoat ink 14.

### <Preparation of Undercoat Ink 15>

5 g of jER (registered trademark) 154 (phenol novolak type epoxy resin, manufactured by Mitsubishi Chemical Corporation) was dissolved in 235 g of diethylene glycol monoethyl ether acetate (ECA) (manufactured by FUJIFILM Wako Pure Chemical Corporation), to which 2.28 g of 4-methylphthalic anhydride (manufactured by Tokyo Chemical Industry Co., Ltd.) was added as a curing agent, and the resultant was an undercoat ink 15.

### <Preparation of Undercoat Ink 16>

0.6 g of polystyrene (weight-average molecular weight: 250000, manufactured by Acros Organics [Belgium]) was weighed, and xylene (manufactured by FUJIFILM Wako Pure Chemical Corporation) was added thereto, so that the total amount became 20 g, which was stirred by a mix rotor for one night. The resultant was an undercoat ink 16.

### <Preparation of Undercoat Ink 17>

0.6 g of polymethyl methacrylate (PARAPET (registered trademark) GH1000S, manufactured by Kuraray Co., Ltd.) was weighed, and diethylene glycol monoethyl ether acetate (ECA) (manufactured by FUJIFILM Wako Pure Chemical Corporation) was added thereto, so that the total amount became 20 g, which was stirred by a mix rotor for 3 days. The resultant was an undercoat ink 17.

### <Preparation of Undercoat Ink 18>

2.4 g of soluble polyimide (SPIXAREA (registered trademark) TP003, manufactured by Somar Corporation) was diluted by 17.6 g of [symbol] γ-butyrolactone (manufactured by FUJIFILM Wako Pure Chemical Corporation), and the resultant was an undercoat ink 18.

Table 1 shows mixing details of the undercoat inks (in the table, abbreviated as “UC ink”) 1 to 18.

TABLE 1

| | | | Curing Agent or Curing | | Curing Agent or Curing | | | | | |
|---|---|---|---|---|---|---|---|---|---|---|
| | Resin | | Accelerator 1 | | Accelerator 2 | | Solvent 1 | | Solvent 2 | |
| | | Amount | | Amount | | Amount | | Amount | | Amount |
| UC Ink | Type | (g) | Type | (g) | Type | (g) | Type | (g) | Type | (g) |
| 1 | Resin Comp. of | 10.0 | | | | | ethyl acetate | 127.0 | | |
| | Syn. Ex. 4 | | | | | | | | | |
| 2 | Resin Comp. of | 10.0 | PETG | 0.63 | U-CAT5003 | 0.31 | 1-hexanol | 83.8 | ethyl acetate | 83.8 |
| | Syn. Ex. 2 | | | | | | | | | |
| 3 | Resin Comp. of | 10.0 | PETG | 0.95 | U-CAT5003 | 0.33 | 1-hexanol | 89.0 | ethyl acetate | 89.0 |
| | Syn. Ex. 3 | | | | | | | | | |
| 4 | Resin Comp. of | 10.0 | PETG | 0.32 | U-CAT5003 | 0.29 | 1-hexanol | 78.6 | ethyl acetate | 78.6 |
| | Syn. Ex. 1 | | | | | | | | | |
| 5 | jER154 | 10.0 | 2E4MZ | 0.50 | | | ECA | 323.0 | | |
| 6 | jER1010 | 10.0 | 2E4MZ | 0.50 | | | ECA | 323.0 | | |
| 7 | jER1002 | 10.0 | YN100 | 1.32 | | | ECA | 366.0 | | |
| 8 | jER1004 | 10.0 | YN100 | 0.92 | | | ECA | 353.1 | | |
| 9 | jER1007 | 10.0 | YN100 | 0.43 | | | ECA | 337.2 | | |
| 10 | jER1009 | 10.0 | YN100 | 0.30 | | | ECA | 333.0 | | |
| 11 | jER1010 | 10.0 | YN100 | 0.21 | | | ECA | 330.1 | | |
| 12 | jER604 | 10.0 | YN100 | 7.13 | | | ECA | 553.9 | | |
| 13 | PETG | 10.0 | YN100 | 9.50 | | | ECA | 630.5 | | |
| 14 | Resin Comp. of | 10.0 | PETG | 0.63 | U-CAT5003 | 0.31 | 1-hexanol | 5.4 | ethyl acetate | 5.4 |
| | Syn. Ex. 2 | | | | | | | | | |
| 15 | jER154 | 5.0 | 4-methylphthalic | 2.28 | | | ECA | 235 | | |
| | | | anhydride | | | | | | | |
| 16 | polystyrene | 0.6 | | | | | xylene | 19.4 | | |
| 17 | polymethyl | 0.6 | | | | | ECA | 19.4 | | |
| | methacrylate | | | | | | | | | |
| 18 | soluble | 2.4 | | | | | γ-butyrolactone | 17.6 | | |
| | polyimide | | | | | | | | | |

### <Preparation of Undercoat Ink 19>

1 g of the undercoat ink 13 was weighed into 10 g of the undercoat ink 2, and mixed well, and the resultant was an undercoat ink 19.

### <Preparation of Undercoat Ink 20>

Except that the amount of the undercoat ink 13 used for preparing the undercoat ink 19 was changed to 2 g, other processes were the same, and the resultant was an undercoat ink 20.

### <Preparation of Undercoat Ink 21>

Except that the amount of the undercoat ink 13 used for preparing the undercoat ink 19 was changed to 3 g, other processes were the same, and the resultant was an undercoat ink 21.

### Example 1

The surface of a transparent substrate (ZEONOR (registered trademark) ZF-14, thickness: 100 μm, A4 size, manufactured by Zeon Corporation) was subjected to plasma treatment (used gas: nitrogen, feed speed: 50 mm/sec, treatment time: 6 sec, set voltage: 400 V) using a plasma processing equipment (AP-T03, manufactured by Sekisui Chemical Co., Ltd.). The undercoat ink 1 was coated on the lower half, in the coating (longitudinal) direction, of the transparent substrate by a bar coater (wet thickness: 5 μm), which was dried by at 80° C., for 1 minute, by using a hot-air drier (constant temperature oven HISPEC HS350 (manufactured by Kusumoto Chemicals Ltd.)), to form an undercoat layer having a thickness of 110 nm. Thereafter, the silver nanowire ink 1 was coated on the entire surface of the A4-size transparent substrate by a bar coater (wet thickness: 15 μm), which was dried by at 80° C., for 1 minute, by using the above hot-air drier, to forma silver nanowire-containing layer (conducting fiber-containing layer) having a thickness of 100 nm.

Accordingly, a transparent film on which a pattern was made by the undercoat layer in the coating direction (the region with the undercoat layer being a high-resistance part, and the region without the undercoat layer being a low-resistance part), was obtained.

### Example 2 to Example 16, Comparative Example 1

Expect that the undercoat inks shown in Table 2 were respectively used, and thermal curing at 100° C. for 15 hours was performed before coating the silver nanowire ink, other processes were the same as those of Example 1, and transparent films were produced. For the thermal curing, the hot-air drier used in Example 1 was also used.

### Comparative Example 2, Comparative Example 3

Expect that the undercoat inks shown in Table 2 were respectively used, and drying at 80° C. for 1 hour was performed before coating the silver nanowire ink, other processes were the same as those of Example 1, and transparent films were produced.

### Comparative Example 4

Expect that the undercoat ink shown in Table 2 was used, and drying at 110° C. for 4 hours was performed before coating the silver nanowire ink, other processes were the same as those of Example 1, and a transparent film was produced.

Table 2 shows measurement results of sheet resistances of the transparent films measured on the undercoat layer (in Table 2, abbreviated as “UC layer”) (high-resistance part) and on the transparent substrate (low-resistance part), regarding each of the transparent films obtained by Example 1 to Example 16 and Comparative Example 1 to Comparative Example 4. The (—NH—) content shown in Table 2 regarding each Example and each Comparative Example is a theoretical value of the total molar number of a group or bonding part having (—NH—) contained per 1 g of a resin solid content (the resin, the curing agent, and the curable accelerator, in total), calculated on the basis of the mixing ratio of the resin (materials for synthesis), the curing agent, and the curable accelerator used for preparing each undercoat ink.

TABLE 2

| | | Sheet | Sheet | | |
|---|---|---|---|---|---|
| | | Resistance on | Resistance on | | —N—H- |
| | | UC Layer | Transparent Base | | Content |
| | UC Ink | R_{H} (Ω/□) | R_{L} (Ω/□) | R_{H}/R_{L} | (mmol/g) |
| Example 1 | UC Ink 1 | NA | 40 | >10⁶ | 1.3 |
| Example 2 | UC Ink 2 | NA | 40 | >10⁶ | 1.8 |
| Example 3 | UC Ink 3 | 10⁴ to 10⁶ | 40 | 250 to | 2.2 |
| | | | | 2.5 × 10⁴ | |
| Example 4 | UC Ink 4 | NA | 40 | >10⁶ | 1.3 |
| Example 5 | UC Ink 5 | NA | 40 | >10⁶ | 0.40 |
| Example 6 | UC Ink 6 | NA | 40 | >10⁶ | 0.40 |
| Example 7 | UC Ink 7 | NA | 40 | >10⁶ | 0.70 |
| Example 8 | UC Ink 8 | NA | 40 | >10⁶ | 0.51 |
| Example 9 | UC Ink 9 | NA | 40 | >10⁶ | 0.25 |
| Example 10 | UC Ink 10 | NA | 40 | >10⁶ | 0.18 |
| Example 11 | UC Ink 11 | NA | 40 | >10⁶ | 0.13 |
| Example 12 | UC Ink 12 | 10⁶ to 10⁷ | 40 | 2.5 × 10⁴ to | 3.7 |
| | | | | 2.5 × 10⁵ | |
| Example 13 | UC Ink 13 | 10⁵ to 10⁶ | 40 | 2.5 × 10³ to | 3.0 |
| | | | | 2.5 × 10⁴ | |
| Example 14 | UC Ink 19 | NA | 40 | >10⁶ | 1.9 |
| Example 15 | UC Ink 20 | 10⁷ | 40 | 2.5 × 10⁵ | 2.0 |
| Example 16 | UC Ink 21 | 10⁷ | 40 | 2.5 × 10⁵ | 2.1 |
| Comparative | UC Ink 15 | 250 | 40 | 6.25 | 0.0 |
| Example 1 | | | | | |
| Comparative | UC Ink 16 | 40 | 40 | 1 | 0.0 |
| Example 2 | | | | | |
| Comparative | UC Ink 17 | 40 | 40 | 1 | 0.0 |
| Example 3 | | | | | |
| Comparative | UC Ink 18 | 100 | 40 | 2.5 | 0.0 |
| Example 4 | | | | | |

### <Resistance Measurement>

Using Loresta (registered trademark) GP MCP-T610, manufactured by Mitsubishi Chemical Analytech Co., Ltd., sheet resistances of arbitrarily selected 10 points on the upper part of the transparent substrate (low-resistance part), and 10 points on the upper part of the undercoat layer (high-resistance part) were measured. Regarding the case that the measurement results were not available at all points, (>10⁸ Φ/□), “NA” is shown. When the sheet resistance measurement result was available, and the result was 1000 Φ/□ or more, the digit number range is shown, and when the result was less than 1000 ω/□, an average value is shown.

At the part where the undercoat is not provided (low-resistance part), the sheet resistance is 40 ω/□. Whereas, in Example 1 to Example 16 using the undercoat resin in which the total content of the group or bonding part having (—NH—) is 0.1 mmol/g or more, the part provided with the undercoat (high-resistance part) has a sheet resistance of more than 100 times of that on the transparent substrate (low-resistance part). In particular, when a resin in which the total content of the group or bonding part having (—NH—) is 0.1 mmol/g or more and less than 2.0 mmol/g is used, the sheet resistance is 10⁸ Φ/□ or more. On the other hand, in Comparative Example 1 to Comparative Example 4 in which the total content of the group or bonding part having (—NH—) is 0.1 mmol/g or less, the ratio between the sheet resistance on the upper part of the transparent substrate (low-resistance part) and the sheet resistance on the upper part of the undercoat layer high-resistance part) is small, i.e., less than ten times. Particularly, the sheet resistance is 40 Φ/□ in both of Comparative Example 2 and Comparative Example 3. Example 14 to Example 16 suggest that even when resins containing different groups or bonding parts having (—NH—) are mixed, the total content of 2.0 mmol/g obtained by respectively calculated content of the group or bonding part having (—NH—) in each resin, is a critical value for determining whether the sheet resistance on the upper part of the undercoat layer (high-resistance part) can be measured or not.

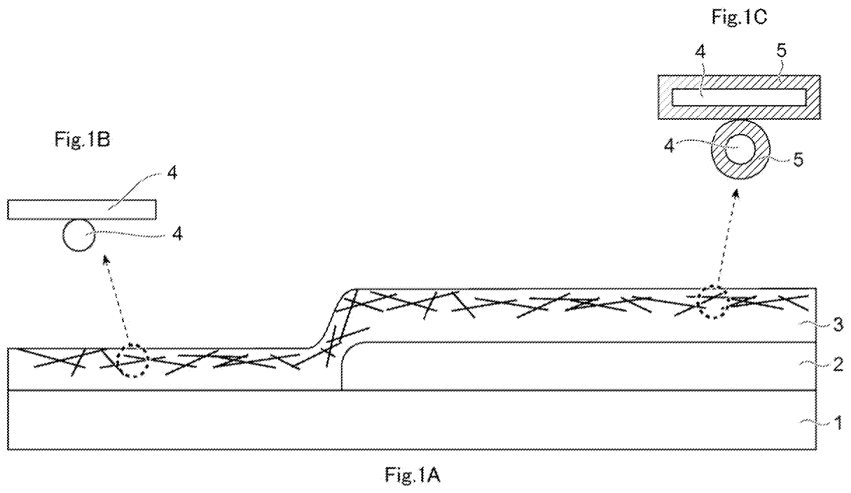

It is not clear why, when an undercoat resin in which the total content of the group or bonding part having (—NH—) is 0.1 mmol/g or more and less than 2.0 mmol/g is used, the region of the conducting fiber-containing layer formed on the undercoat layer becomes a high-resistance part having a sheet resistance exceeding 10⁸ ω/□. However, the reasons therefor can be considered as principals shown in FIG. 1A, FIG. 1B, and FIG. 1C. Here, FIG. 1A is a cross-sectional view the transparent film according to Examples. FIG. 1B is a partly enlarged view of the region where the conducting fiber-containing layer is directly coated on the substrate. FIG. 1C is a partly enlarged view of the region where the conducting fiber-containing layer is coated on the undercoat layer.

As in FIG. 1A, FIG. 1B, and FIG. 1C, it is assumed that: the region of the conducting fiber-containing layer 3 formed on the undercoat layer 2 (FIG. 1C) has a structure in which functional groups (hydrophilic groups such as a carbonyl group, a hydroxyl group, etc.) in the binder resin 5 gather around the conducting fiber 4; the conducting fiber 4 is surrounded by a larger amount of binder resin 5, compared to the case that the conducting fiber-containing layer 3 is directly coated on the transparent substrate 1 (FIG. 1B); and thus, the binder resin 5 is located at the intersections of the conducting fibers 4, resulting in losing electrical contact and having a high sheet resistance of exceeding 10⁸ ω/□.

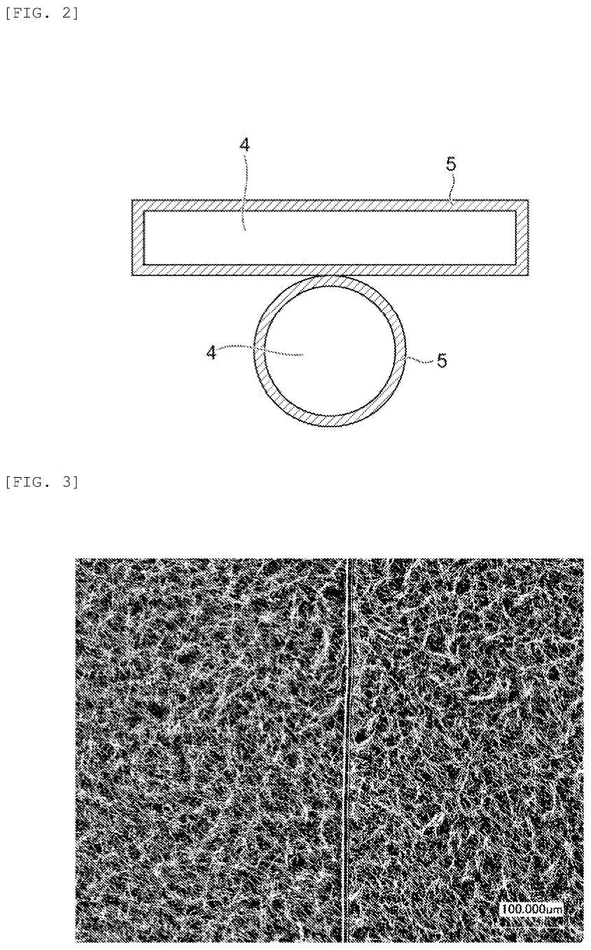

Alternatively, in case that an undercoat resin 2 in which the total content of the group or bonding part having (—NH—) is 2.0 mmol/g or more is used, hydrophilic groups in the binder resin 5 of the silver nanowire ink tend to be oriented to the surface of the undercoat layer 2. Thus, as shown in FIG. 2, the binder resin 5 around the conducting fiber 4 becomes a little thinner compared to the case shown in FIG. 1C. As a result, a tunnel current is generated, or at a region where the binder resin 5 is thin, part of conducting fibers 4 can be in contact at intersections. However, the flowing of the tunnel current or the contact of conducting fibers do not occur at all intersections of conducting fibers 4. It is assumed that because of the above, a high sheet resistance of 1000 Φ/□ or more is obtained.

On the other hand, when the silver nanowire-containing layer (conducting fiber-containing layer 3) is formed on the transparent substrate 1 without the undercoat layer 2 therebetween, because there are no groups or bonding parts having (—NH—) on the surface, the binder resin 5 contained in the silver nanowire ink wets and spreads from around the conducting fiber 4, and as shown in FIG. 1B, only a very thin binder resin 5 remains around the conducting fiber 4 (the binder resin is not shown because it is very thin), and thus, electrical contact can be obtained at most of the intersections of the conducting fibers 4. It is assumed that because of the above, the sheet resistance becomes low.

### Example 17 to Example 19

Except that the silver nanowire ink 1 used in Example 2 was changed to the inks shown in Table 3, the transparent conductive films were produced in the same way. Table 3 shows measurement results of sheet resistances measured at low-resistance parts and high-resistance parts of conducting fiber-containing layers respectively obtained by Example 2 and Example 17 to Example 19.

TABLE 3

| | | | Sheet | Sheet | |
|---|---|---|---|---|---|
| | | | Resistance on | Resistance on | |
| | | | UC Layer | Transparent Base | |
| | UC Ink | Silver Nanowire Ink | R_{H} (Ω/□) | R_{L} (Ω/□) | R_{H}/R_{L} |
| Example 2 | UC Ink 2 | Silver Nanowire Ink 1 | NA | 40 | >10⁶ |
| Example 17 | UC Ink 2 | Silver Nanowire Ink 2 | NA | 40 | >10⁶ |
| Example 18 | UC Ink 2 | Silver Nanowire Ink 4 | NA | 40 | >10⁶ |
| Example 19 | UC Ink 2 | Silver Nanowire Ink 3 | 10⁶ | 40 | 2.5 × 10⁴ |

As shown in Table 3, the sheet resistance on the undercoat layer may be measured because of the binder resin of the silver nanowire ink (Example 19). Taking the structure of the binder resin into account, it is assumed that interaction between the silver nanowires and the binder resin may be related. It is known that because a carbonyl group is present in the binder resin, adsorption to the silver nanowires occurs (J. Phys. Chem. B 2004, 108. 12877). The binder resin in the metal nanowire ink (silver nanowire ink 3) used in Example 19 does not contain a carbonyl group, and thus, the binder resin easily desorbs from the surrounding region of the silver nanowire, resulting in making the contact at the intersections of the metal nanowires easier.

### Example 20 to Example 24

Except that undercoat ink and the wet thickness of bar used for coating same in Example 2 were changed to those shown in Table 4, to change the film thickness, the transparent films were produced in the same way. In Example 24, the drying was performed at 80° C., for 15 minutes.

Table 4 shows measurement results of sheet resistances measured at low-resistance parts and high-resistance parts of the transparent films respectively obtained by Example 2 and Example 20 to Example 24.

### <Measurement of Thickness>

The thickness of the undercoat layer was measured by a film thickness measurement system F20-UV (manufactured by Filmetrics Corporation), based on optical interferometry. Measurement was performed at different points, and an average value of measurement results at three points was used as a thickness. For analysis, spectra of 450 nm to 800 nm were used. By this measurement system, the thickness of the undercoat layer formed on the transparent substrate can be directly measured. Table 4 shows the measurement results.

Table 4 reveals that even in the case that the film thickness measured by the optical film thickness measurement instrument (F20-UV) is very small, i.e., 30 nm, and in the case that the film thickness is very large, i.e., 10000 nm (10 μm), the resistances are high.

TABLE 4

| | | | Film | | Sheet | |
|---|---|---|---|---|---|---|
| | | | Thickness | Sheet | Resistance | |
| | | Bar Wet | After | Resistance | on Transparent | |
| | | Thickness | Drying | on UC Layer | Base | R_{H}/ |
| | UC Ink | (μm) | (nm) | R_{H}(Ω/□) | R_{L}(Ω/□) | R_{L} |
| Example 20 | UC Ink 2 | 1 | 30 | NA | 40 | >10⁶ |
| Example 21 | UC Ink 2 | 3 | 70 | NA | 40 | >10⁶ |
| Example 2 | UC Ink 2 | 5 | 110 | NA | 40 | >10⁶ |
| Example 22 | UC Ink 2 | 7 | 150 | NA | 40 | >10⁶ |
| Example 23 | UC Ink 2 | 15 | 310 | NA | 40 | >10⁶ |
| Example 24 | UC Ink 14 | 46 | 10000 | NA | 40 | >10⁶ |

The above reveals that both in the case that a negative pattern of the conductive pattern is drawn by pattern printing using a screen plate or inkjet printing, or in the case that the undercoat layer is solid-printed, and thereafter processed to become a negative patten of the conductive pattern, the silver nanowires on the undercoat layer become non-conductive (high-resistance part), and the part without the undercoat layer becomes conductive (becomes a low-resistance part).

### Example 25

The surface of a transparent substrate (ZEONOR (registered trademark) ZF-14, thickness: 100 μm, A4 size, manufactured by Zeon Corporation) was subjected to plasma treatment (used gas: nitrogen, feed speed: 50 mm/sec, treatment time: 6 sec, set voltage: 400 V) using a plasma processing equipment (AP-T03, manufactured by Sekisui Chemical Co., Ltd.). The undercoat ink 2 was coated on the lower half, in the coating (longitudinal) direction, of the transparent substrate by a bar coater (wet thickness: 3 μm), which was dried by at 80° C., for 1 minute, by using a hot-air drier (constant temperature oven HISPEC HS350 (manufactured by Kusumoto Chemicals Ltd.)), which was thereafter treated by the above hot-air drier at 100° C., for 15 hours to form an undercoat layer having a thickness of 70 nm. Thereafter, the silver nanowire ink 1 was coated on the entire surface of the A4-size substrate with the undercoat layer by a bar coater (wet thickness: 15 μm), which was dried by at 80° C., for 1 minute, to form a silver nanowire-containing layer (conducting fiber-containing layer) having a thickness of 100 nm.

Thereafter, as a protection layer, the undercoat ink 2 was coated on the entirety of the A4-size surface by a bar coater (wet thickness: 7 μm), which was dried by at 80° C., for 1 minute. Thereby, a transparent film having the conductive layer protected by the 150 nm-thick protection layer formed thereon was obtained.

### Example 26 to Example 28

Except that the transparent substrate and the undercoat ink for forming the undercoat layer of Example 25 were changed to combinations shown in Table 5, the transparent films were produced in the same way as Example 25. In Example 27 and Example 28 where T60 (PET film, thickness: 50 μm, A4 size, manufactured by Toray Industries, Inc.) was used as a transparent substrate, the plasma treatment of the surface was not performed.

### Comparative Example 5

The surface of a transparent substrate (ZEONOR (registered trademark) ZF-14, thickness: 100 μm, A4 size, manufactured by Zeon Corporation) was subjected to plasma treatment, under the same conditions as Example 25 and Example 26. The silver nanowire ink 1 was coated on the entire surface of the A4-size substrate, in the coating (longitudinal) direction, of the transparent substrate by a bar coater (wet thickness: 15 μm), which was dried by at 80° C., for 1 minute, by using a hot-air drier (constant temperature oven HISPEC HS350 (manufactured by Kusumoto Chemicals Ltd.)), to form a silver nanowire-containing layer (conducting fiber-containing layer) having a thickness of 100 nm.

Thereafter, as a protection layer, the undercoat ink 2 was coated on the entirety of the A4-size surface by a bar coater (wet thickness: 7 μm), which was dried by at 80° C., for 1 minute by the above hot-air drier. Thereby, a transparent film having the conductive layer protected by the 150 nm-thick protection layer formed thereon was obtained.

Half of the obtained transparent film was immersed in an etching liquid (SEA-NW01, manufactured by Kanto Chemical Co., Inc.) for 1 minute, and thereafter, washed with pure water and dried. Thereby, a transparent film having a pattern formed by etching was obtained.

Table 5 shows sheet resistances at the low-resistance part and the high-resistance part of films obtained in Example 25 to Example 28, and Comparative Example 5, respectively.

TABLE 5

| | | | Properties of Low | | | Properties of High | | | |
|---|---|---|---|---|---|---|---|---|---|
| | | | Resistance Part | | | Resistance Part | | | |
| | | | Total | | Sheet | Total | | Sheet | |
| | | | Light | | Resistance | Light | | Resistance | |
| | | | Transmittance | Haze | R_{L} | Transmittance | Haze | R_{H} | R_{H}/ |
| | Base | UC Ink | (%) | (%) | (Ω/□) | (%) | (%) | (Ω/□) | R_{L} |
| Example 25 | ZF14-100 | UC Ink 2 | 89.90 | 0.75 | 40 | 89.94 | 0.74 | NA | >10⁶ |
| Example 26 | ZF14-100 | UC Ink 5 | 89.91 | 0.77 | 40 | 89.71 | 0.78 | NA | >10⁶ |
| Example 27 | T60 | UC Ink 2 | 86.05 | 2.29 | 40 | 86.79 | 2.35 | NA | >10⁶ |
| Example 28 | T60 | UC Ink 5 | 86.04 | 2.31 | 40 | 86.69 | 2.33 | NA | >10⁶ |
| Comparative | ZF14-100 | None | 89.72 | 0.82 | 40 | 91.86 | 0.12 | NA | >10⁶ |
| Example 5 | | | | | | | | | |

### <Total Light Transmittance, Haze Measurement>

Test pieces, each having 3 cm×3 cm, were cut out from the low-resistance part and the high-resistance part of each film obtained in Example 25 to Example 28 and Comparative Example 5. In compliant with JIS K7361-1, a total light transmittance measurement method for transparent materials, and JIS K7136, a method for obtaining haze of transparent materials, a total light transmittance and a haze of each test piece was measured with a light source D65, using a spectrophotometer for color, oil & haze COH7700 (manufactured by Nippon Denshoku Industries Co., Ltd.). Table 5 shows the measurement results.

In Comparative Example 5, silver nanowires in the high-resistance part are removed by etching, and thus, optical properties are different between the low-resistance part and the high-resistance part. Example 25 to Example 28 having a feature of the present disclosure that the high-resistance part and the low-resistance part are distinguished by the presence/absence of the undercoat layer, have almost the same optical properties, regardless of the types of the transparent substrate and the undercoat resin, and preferable pattern films with no visible pattern are obtained. FIG. 3 shows an image of Example 25 observed by a laser microscope (Shape Measurement Laser Microscope VK-X200 (manufactured by Keyence Corporation). The vertical line at the center of FIG. 3 indicates a boundary of the undercoat layer, and the left side of the line shows an image on the transparent substrate (without the undercoat layer, corresponding to FIG. 1B), and right side shows an image on the undercoat layer (with the undercoat layer, corresponding to FIG. 1C). No difference in the concentration (deposition distribution) of conducting fiber (silver nanowire) is found between the image on the transparent substrate and the image on the UC layer, and thus, the objective transparent film having a superior non-visibility is obtained.

1. A transparent film comprising a transparent substrate, and a conducting fiber-containing layer stacked on at least one main face of the transparent substrate, the conducting fiber-containing layer containing conducting fibers substantially evenly dispersed in a plan view, and a binder resin,
wherein the transparent film has a high-resistance part where an undercoat layer is partly provided between the transparent substrate and the conducting fiber-containing layer, and a low-resistance part where no undercoat layer is provided between the transparent substrate and the conducting fiber-containing layer,
a sheet resistance value R_{H} of the high-resistance part and a sheet resistance value R_{L} of the low-resistance part satisfy R_{H}/R_{L}>100, and
the undercoat layer contains a resin having at least one group or bonding part having (—NH—).

2. A transparent film according to claim 1, wherein a total content of the group or bonding part having (—NH—) in the undercoat layer is 0.1 mmol/g or more and 5.0 mmol/g or less.

3. A transparent film according to claim 2, wherein the total content of the group or bonding part having (—NH—) is less than 2.0 mmol/g.

4. A transparent film according to claim 1, wherein the group or bonding part having (—NH—) is at least one selected from a group consisting of a primary amino group, a secondary amino group, a urethane bond (—NH—C(═O)—O—), a urea bond (—NH—C(═O)—NH—), and an amide bond (—C(═O)—NH—).

5. A transparent film according to claim 1, wherein the binder resin is a poly-N-vinylacetamide (homopolymer of N-vinylacetamide (NVA)) or a copolymer having 70 mol % or more of N-vinylacetamide (NVA).

6. A transparent film according to claim 1, wherein the undercoat layer has a thickness of 10 to 30000 nm.

7. A transparent film according to claim 1, wherein an overcoat layer (protection film layer) is provided on the conducting fiber-containing layer.

8. A transparent film according to claim 1, wherein the conducting fiber is a metal nanowire.

9. A transparent film according to claim 8, wherein the metal nanowire is a silver nanowire.

10. A manufacturing method for a transparent film comprising:
a first step for forming a undercoat layer which covers at least a part of at least one main face of a transparent substrate, and
a second step for forming a conducting fiber-containing layer having conducting fibers substantially evenly dispersed in a plan view, the conducting fiber-containing layer covering the undercoat layer as well as a region where no undercoat layer is provided to expose a surface of the transparent substrate,
wherein a sheet resistance value R_{H} of the high-resistance part where the undercoat layer is provided and a sheet resistance value R_{L} of the low-resistance part where no undercoat layer is provided satisfy R_{H}/R_{L}>100, and
the undercoat layer contains a resin having at least one group or bonding part having (—NH—).

11. A manufacturing method for a transparent film according to claim 10, wherein the first step comprises a step of performing pattern printing of the undercoat ink to form a region where the undercoat layer is present and a region where no undercoat layer is present.

12. A manufacturing method for a transparent film according to claim 10, wherein the first step comprising:
an undercoat layer forming step to apply solid print of the undercoat ink on the transparent substrate, and
a step of forming a region with the undercoat layer and a region without the undercoat layer by performing pattern etching of the solid-printed undercoat layer.

13. A manufacturing method for a transparent film according to claim 10, wherein the second step comprising:
a step of solid printing of the conducting fiber-containing ink containing conducting fibers, a binder resin, and a solvent, and
a step of drying the solvent.
